(19) United States
(12) Patent Application Publication
(10) Pub. No.: US 2026/0353024 A1
(43) Pub. Date: Nov. 5, 2026

(54) METHOD, APPARATUS, DEVICE AND STORAGE MEDIUM FOR AUDIO PROCESSING

(71) Applicant: Beijing Zitiao Network Technology Co., Ltd., Beijing (CN)

(72) Inventors: Xuechao ZHI, Beijing (CN); Junzheng WANG, Beijing (CN); Hao ZHANG, Beijing (CN)

(21) Appl. No.: 19/664,838

(22) Filed: Apr. 30, 2026

(30) Foreign Application Priority Data
Apr. 30, 2025 (CN) 202510573034.8

(51) Int. Cl. H04S 7/00; G06F 3/16; H04N 21/2187; H04N 21/233; H04N 21/81

(52) U.S. Cl. CPC H04S 7/302; G06F 3/165; H04N 21/2187; H04N 21/233; H04N 21/8106; H04S 2400/11

(57) ABSTRACT

The disclosure provides a method, apparatus, device, and storage medium for audio processing. The method includes: determining at least one participant joining a chorus event of a live streaming; determining at least one spatial parameter corresponding to the at least one participant respectively based on layout information corresponding to the at least one participant, each of the at least one spatial parameter indicating a relative positional relationship corresponding to a corresponding participant and a reference listening party of music; and obtaining a chorus audio stream for the chorus event, the chorus audio stream being generated by: processing at least one audio stream corresponding to the at least one participant using the at least one spatial parameter.

### CROSS REFERENCE

The present application claims priority to Chinese Patent Application No. 202510573034.8, filed on Apr. 30, 2025, entitled “METHOD, APPARATUS, DEVICE AND STORAGE MEDIUM FOR AUDIO PROCESSING”, which is incorporated herein by reference in its entirety.

### FIELD

Example embodiments of the present disclosure generally relate to the field of computers, and in particular, to a method, an apparatus, a device, a computer-readable storage medium, and a computer program product for audio processing.

### BACKGROUND

With the rapid development of Internet technologies, live streaming interaction has gradually become a new way of information exchange. For example, in a chorus event of a live streaming, a plurality of participants may sing the same piece of music. Thereafter, a plurality of audio streams corresponding to the plurality of participants may be merged to form a chorus audio stream. In this way, the interactive mode of collective chorus in a real scenario may be restored.

### SUMMARY

In a first aspect of the present disclosure, a method of audio processing is provided. The method includes: determining at least one participant joining a chorus event of a live streaming; determining at least one spatial parameter corresponding to the at least one participant respectively based on layout information corresponding to the at least one participant, the layout information indicating a layout of the at least one participant on a live streaming chorus interface, and each of the at least one spatial parameter indicating a relative positional relationship corresponding to a participant and a reference listening party; and obtaining a chorus audio stream for the chorus event, the chorus audio stream being generated by: processing at least one audio stream corresponding to the at least one participant using the at least one spatial parameter.

In a second aspect of the present disclosure, a method of audio processing method is provided. The method includes: receiving, from a terminal device associated with a streamer party of a chorus event of a live streaming, at least one spatial parameter indicating a relative positional relationship corresponding to at least one participant joining the chorus event and a reference listening party, respectively; receiving at least one audio stream corresponding to the chorus event from the at least one participant; performing, based on each of the at least one spatial parameter, processing on a corresponding audio stream of the at least one audio stream to obtain at least one processed audio stream; and generating a chorus audio stream at least based on the at least one processed audio stream.

In a third aspect of the present disclosure, an apparatus for audio processing is provided. The apparatus includes: a participant determination module configured to determine at least one participant joining a chorus event of live streaming; a parameter determination module configured to determine at least one spatial parameter corresponding to the at least one participant respectively based on layout information corresponding to the at least one participant, the layout information indicating a layout of the at least one participant on a live streaming chorus interface, and each of the at least one spatial parameter indicating a relative positional relationship corresponding to a participant and a reference listening party; and an audio stream obtaining module configured to obtain a chorus audio stream for the chorus event, the chorus audio stream being generated by: processing at least one audio stream corresponding to the at least one participant using the at least one spatial parameter.

In a fourth aspect of the present disclosure, an apparatus for audio processing is provided. The apparatus includes: a parameter receiving module configured to receive, from a terminal device associated with a streamer party of a chorus event of live streaming, at least one spatial parameter indicating a relative positional relationship corresponding to at least one participant joining the chorus event and a reference listening party, respectively; an audio stream receiving module configured to receive at least one audio stream corresponding to the chorus event from the at least one participant; an audio stream processing module configured to perform, based on each of the at least one spatial parameter, processing on a corresponding audio stream of the at least one audio stream to obtain at least one processed audio stream; and an audio stream generation module configured to generate a chorus audio stream at least based on the at least one processed audio stream.

In a fifth aspect of the present disclosure, an electronic device is provided. The device includes at least one processor; and at least one memory, the at least one memory being coupled to the at least one processor and storing instructions executable by the at least one processor, the instructions, when executed by the at least one processor, causing the device to perform the method of the first aspect or the second aspect.

In a sixth aspect of the present disclosure, a non-transitory computer-readable storage medium is provided. The computer-readable storage medium has computer-executable instructions stored thereon, the computer-executable instructions being executable by a processor to implement the method of the first aspect or the second aspect.

In a seventh aspect of the present disclosure, a computer program product is provided. The product includes computer-executable instructions, where the computer-executable instructions, when executed by a processor, implement the method of the first aspect or the second aspect according to the present disclosure.

It should be understood that the contents described in this section are neither intended to limit the key features or important features of the embodiments of the present disclosure, nor are they intended to limit the scope of the present disclosure. Other features of the present disclosure will be readily understood from the following description.

### BRIEF DESCRIPTION OF THE DRAWINGS

The above and other features, advantages, and aspects of the embodiments of the present disclosure will become more apparent in conjunction with the accompanying drawings and with reference to the following detailed description. In the drawings, the same or similar reference numerals represent the same or similar elements, where:

FIG. 1 illustrates a schematic diagram of an example environment in which the embodiments of the present disclosure can be implemented;

FIG. 2 illustrates a flowchart of an audio processing procedure according to some embodiments of the present disclosure;

FIG. 3 illustrates a flowchart of a signaling flow of audio processing according to some embodiments of the present disclosure;

FIGS. 4A and 4B respectively illustrate schematic diagrams of examples of layouts according to some embodiments of the present disclosure;

FIG. 4C illustrates a schematic diagram of an example of an arrangement interface according to some embodiments of the present disclosure;

FIG. 5 illustrates a schematic structural block diagram of an example apparatus for audio processing according to some embodiments of the present disclosure;

FIG. 6 illustrates a schematic structural block diagram of an example apparatus for audio processing according to some other embodiments of the present disclosure; and

FIG. 7 illustrates a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be interpreted as being limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other definitions, both explicit and implicit, may also be included below.

Herein, unless otherwise clearly stated, "performing a step in response to A" does not mean that the step is performed immediately after "A", but may include one or more intermediate steps.

It may be understood that the data involved in the technical solution (including but not limited to the data itself, acquisition or use of the data) should comply with the requirements of corresponding laws, regulations, and related provisions.

It may be understood that before using the technical solution disclosed in the embodiments of the present disclosure, the user should be informed of the type, range of use, use scenarios, etc., of personal information involved in the present disclosure and the authorization of the user should be obtained in an appropriate manner in accordance with relevant laws and regulations.

For example, in response to receiving an active request from a user, prompt information is sent to the user to clearly prompt the user that the requested operation will require access to and use of the user’s personal information, so that the user may independently choose whether to provide the personal information to software or hardware, such as an electronic device, an application, a server, or a storage medium, that performs the operations of the technical solution of the present disclosure based on the prompt information.

As an optional but non-restrictive implementation, in response to receiving an active request from a user, a way to send prompt information to the user, for example, may be a pop-up window, in which the prompt information may be presented in text. In addition, the pop-up window may also include a selection control for the user to choose whether to "agree" or "disagree" to provide the personal information to the electronic device.

It may be understood that the above process of notifying and obtaining user authorization is only illustrative, and does not limit the implementations of the present disclosure. Other ways that satisfy relevant laws and regulations may also be applied to the implementations of the present disclosure.

As mentioned above, with the rapid development of Internet technologies, live streaming interaction has gradually become a new way of information exchange. For example, in a chorus event of live streaming, a plurality of participants may sing the same piece of music. Thereafter, a plurality of audio streams corresponding to the plurality of participants may be merged to form a chorus audio stream, so as to restore the interactive mode of collective chorus in a real scenario. However, in a traditional music chorus live streaming, a plurality of audio streams are directly merged to form a chorus audio stream, and voices of different participants easily overlap, which makes it difficult to distinguish the voices of different participants, and the sense of space is poor. Therefore, in the scenario of music chorus live streaming, the synthesis quality of the chorus audio stream still needs to be improved.

In view of this, according to an embodiment of the present disclosure, an improved solution for audio processing is provided. In this solution, at least one participant joining a chorus event of live streaming is determined. At least one spatial parameter corresponding to the at least one participant is determined respectively based on layout information corresponding to the at least one participant. The layout information may indicate a layout of the at least one participant on a live streaming chorus interface. Each spatial parameter may indicate a relative positional relationship corresponding to a participant and a reference listening party of the music. Thereafter, at least one audio stream corresponding to the at least one participant is processed using the at least one spatial parameter to obtain a chorus audio stream for the chorus event.

In the embodiments of the present disclosure, processing a corresponding audio stream using a spatial parameter may form an audio stream having a spatial audio effect. The chorus audio stream formed by merging audio streams based on the spatial audio effect may simulate, to a certain extent, the sound effect of music chorus in a chorus formation corresponding to the corresponding layout, which may bring immersive audio-visual experience to the listeners. Moreover, voice overlap is not likely to occur in the chorus audio stream, so that the listeners may distinguish voices of more participants from the chorus audio stream, which in turn allows more participants to participate in the chorus event.

Various example implementations of the solution will be described in detail below in further combination with the drawings.

### EXAMPLE ENVIRONMENT

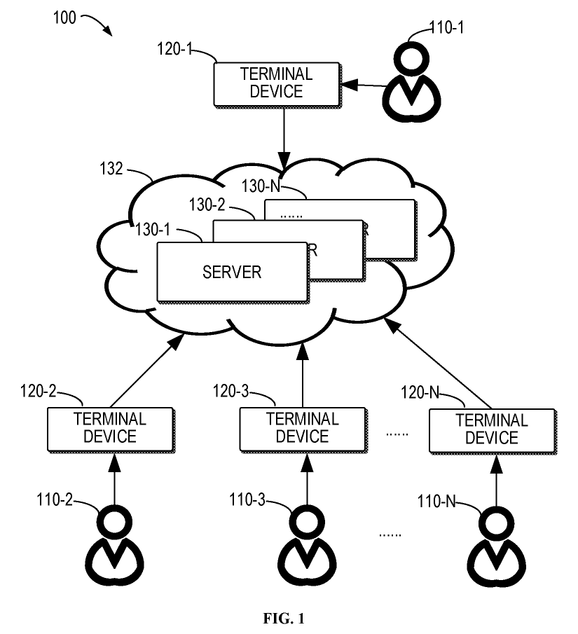

FIG. 1 illustrates a schematic diagram of an example environment 100 in which the embodiments of the present disclosure may be implemented. In the environment 100, one or more users 110-1, 110-2, 110-3, ..., 110-N may watch live streaming and participate in live streaming events, etc., through their associated terminal devices 120-1, 120-2, ..., 120-N, respectively. For example, the users 110 may also be referred to as participants. For the convenience of discussion, the users 110-1, 110-2, ..., 110-N may be collectively or individually referred to as the user 110, and the terminal devices 120-1, 120-2, ..., 120-N may be collectively or individually referred to as the terminal device 120. Among all the users 110, one or more users, such as the user 110-1, may establish a live streaming event and initiate live streaming through the associated terminal device 120-1.

In some scenarios, the user 110-1 who initiates live streaming may also be referred to as a streamer, a streamer participant, a live streaming party, or a live streaming management party of the live streaming event. The one or more other users 110 may include a guest participant 110-N to represent a user who participates in the live streaming interaction initiated by the streamer. In addition to the guest participant participating in the live streaming interaction, the other users 110 may also include viewers, listeners, or viewing parties of the live streaming event.

In some embodiments, the terminal device 120 may be respectively installed with an application that may provide a live streaming service, or may access a website that may provide the live streaming service. The user 110 may operate the terminal device 120 to access the corresponding application or website. Correspondingly, the terminal device 120 may present a corresponding live streaming interface, which for example may provide live streaming content of a live streaming room, such as audio live streaming content or video live streaming content.

In the embodiment of the present disclosure, the environment 100 may include one or more servers 130-1, 130-2, ..., 130-N. In some embodiments, the terminal device 120 may also communicate with the servers 130-1, 130-2, ..., 130-N through the network 132 to implement the provision of live streaming services. The one or more servers 130-1, 130-2, ..., 130-N may individually or collaboratively implement the provision of live streaming services for the terminal device 120. In some embodiments, the servers 130-1, 130-2, ..., 130-N may store data generated during a live streaming event, including live streaming interaction data generated in live streaming interaction.

The terminal device 120 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a game device, or any combination of the foregoing, including fittings and peripherals of these devices or any combination thereof. In some embodiments, the terminal device 120 may also support any type of user-specific interface (such as a "wearable" circuit, etc.). The server 130 may be various types of computing systems/servers that may provide computing power, including but not limited to mainframes, edge computing nodes, computing devices in cloud environments, etc.

It should be understood that the structure and function of each element in the environment 100 are described for exemplary purposes only, and do not imply any limitation on the scope of the present disclosure.

Some example embodiments of the present disclosure will be described below with continued reference to the drawings.

### Example Procedure

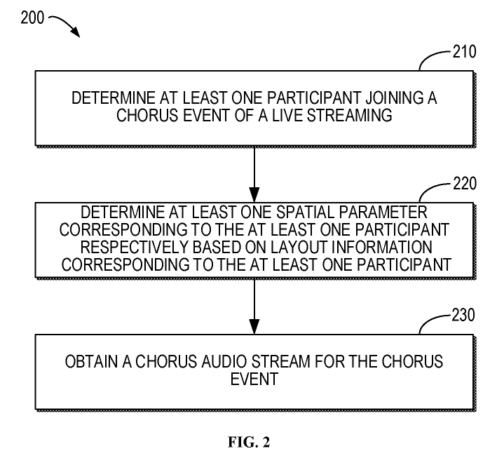

Some example embodiments of the present disclosure will be described below with continued reference to the drawings. FIG. 2 illustrates a flowchart of an audio processing procedure 200 according to some embodiments of the present disclosure. Part or entirety of the procedure 200 may be implemented by the terminal device 120, or may be implemented by the terminal device 120 in cooperation with the server 130. Hereinafter, for the convenience of discussion, the execution of the procedure 200 is described from the perspective of the terminal device 120, but this is only exemplary. In some examples, the terminal device 120 may be a terminal device of a streamer party. Certainly, the terminal device 120 may also be a terminal device of another participant in the chorus event, and the embodiment of the present disclosure is not limited thereto.

At block 210, the terminal device 120 determines at least one participant joining a chorus event of a live streaming. The chorus event may be understood as an event of performing music chorus in live streaming. The at least one participant may be understood as a participant who participates in the music chorus and whose corresponding audio stream will be used to synthesize a chorus audio stream. In some embodiments, the live streaming may include a streamer party and a plurality of viewing parties who join the live streaming, and any of the streamer party and the plurality of viewing parties may choose to join the chorus event. The at least one participant may be selected from the plurality of participants who join the chorus event, and the audio stream corresponding to the at least one participant will be used to synthesize the chorus audio stream.

As an example, the server 130 may determine scores of the respective audio streams of the plurality of participants. The server 130 may rank the plurality of participants based on the scores, and select a predetermined number of top-ranked participants from the ranking. The audio streams of the predetermined number of participants will be used to synthesize the chorus audio stream. The terminal device 120 may receive an indication (e.g., a list) of the predetermined number of participants from the server 130. In this way, an audio stream with better sound quality may be selected from the participants who join the chorus event to generate the chorus audio stream.

It should be understood that the above participant determination strategy is only exemplary. In practical applications, any other appropriate way may be used to select a participant for synthesizing the chorus audio stream from the plurality of participants who join the chorus event. For example, the terminal device 120 may also determine the at least one participant according to the selection of the streamer party. It should also be noted that the at least one participant may change dynamically during the live streaming. For example, the server 130 may update the score of the audio stream of the participant at intervals of a predetermined duration to update the at least one participant.

In some embodiments, the terminal device 120 may determine the at least one participant from a plurality of participants based on respective roles of the plurality of participants who join the chorus event. The role of each participant indicates whether the participant is a lead singer role or a background singer role of the music. In some examples, the terminal device 120 may select at least one participant corresponding to the background singer role from the plurality of participants. In this way, the audio stream of the background singer role may be selectively processed subsequently.

As an example, FIG. 3 illustrates a flowchart of a signaling flow 300 of audio processing according to some embodiments of the present disclosure. The signaling flow 300 involves a server 130-1, a server 130-2, a terminal device 120-1, and a terminal device 120-2. In some examples, the terminal device 120-1 may be a terminal device associated with a streamer party, and the terminal device 120-2 may be a terminal device associated with other participants who join the chorus event.

As shown in FIG. 3, the server 130-1 may send (302) information related to selected music to the terminal device 120-1 in response to a selection of music (which may also be referred to as song ordering) by a participant (e.g., a streaming host party or a viewing party). The information related to the music may include an indication of the music (e.g., a track), and may also include an indication of a lead singer role, such as an identifier of the lead singer role. The terminal device 120-1 may determine (304) a participant corresponding to the lead singer role based on the identifier. The server 130-1 may also determine a list of participants based on a predetermined strategy. The list indicates a participant corresponding to the lead singer role and a participant corresponding to a background singer role. The server 130-1 may send (306) the list to the terminal device 120-1. The terminal device 120-1 may determine (308) at least one participant corresponding to the background singer role based on the list.

Returning to the procedure 200, at block 220, the terminal device 120 determines at least one spatial parameter corresponding to the at least one participant respectively based on layout information corresponding to the at least one participant. The layout information may indicate a layout of the at least one participant on a live streaming chorus interface. The layout may indicate a chorus formation of the at least one participant. In some examples, the layout may indicate a relative positional relationship, such as a relative distance or a relative angle, between the chorus formation composed of the at least one participant and a reference listening party. The reference listening party may be understood as a virtual listening party, which is used to assist in identifying a relative position between a chorus queue and a listening party. The live streaming chorus interface may be an interface presented during live streaming, or may be an arrangement interface used to configure the chorus formation of the at least one participant. Each of the at least one spatial parameter indicates a relative positional relationship corresponding to a participant and the reference listening party of the music.

In some embodiments, the reference listening party may have a default spatial coordinate, and the at least one spatial parameter may include at least one spatial coordinate corresponding to the at least one participant. In a case that the layout information corresponding to the at least one participant is obtained, the terminal device 120 may determine the layout of the at least one participant on the live streaming chorus interface based on the layout information. The terminal device 120 may determine at least one spatial coordinate corresponding to the at least one participant based on the layout.

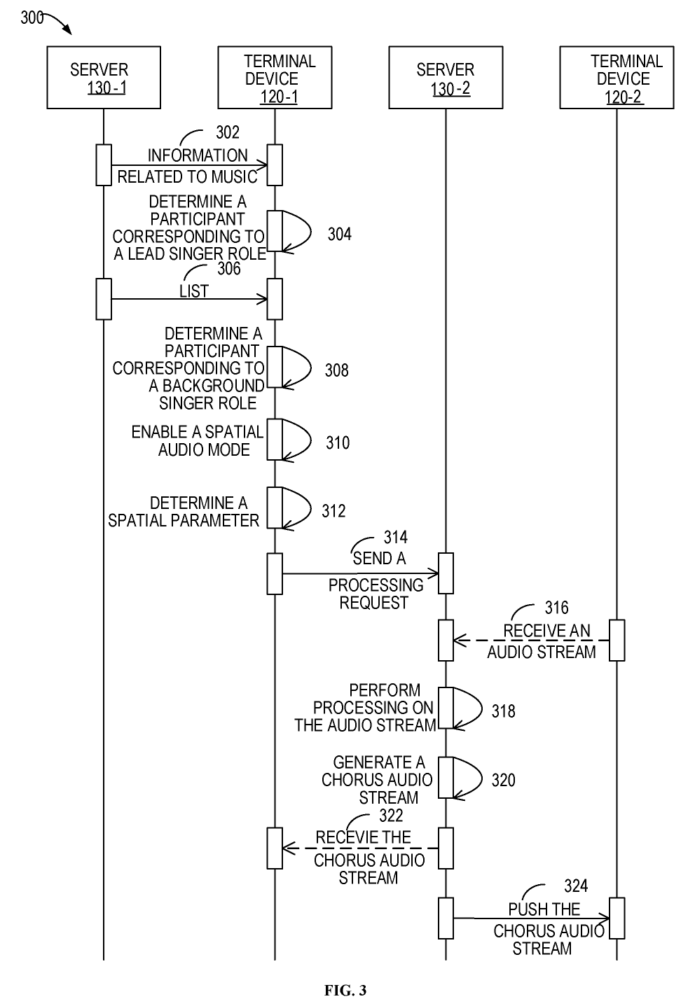

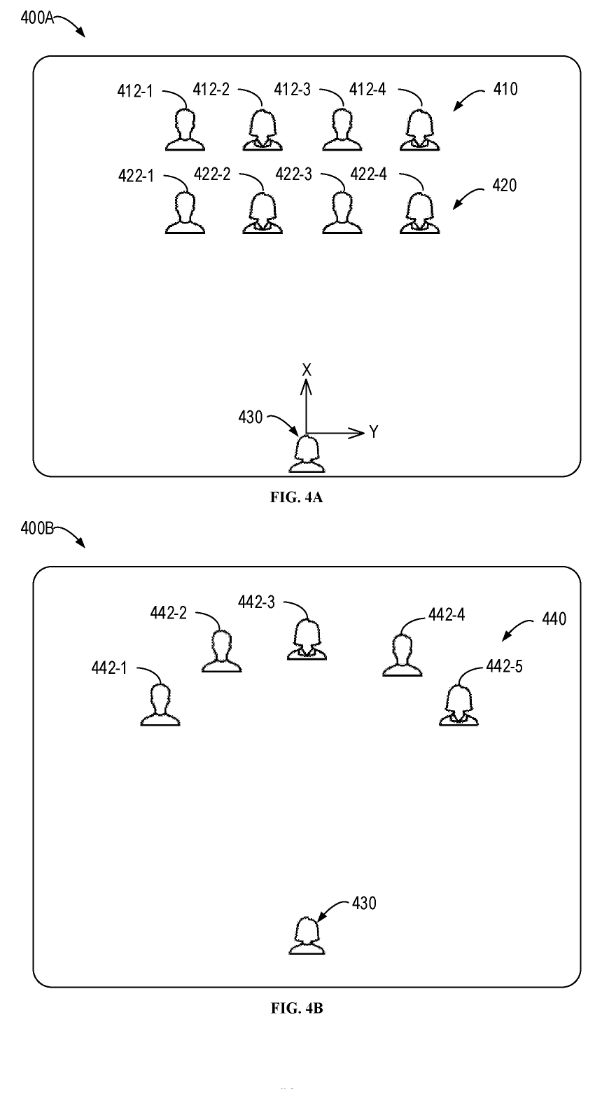

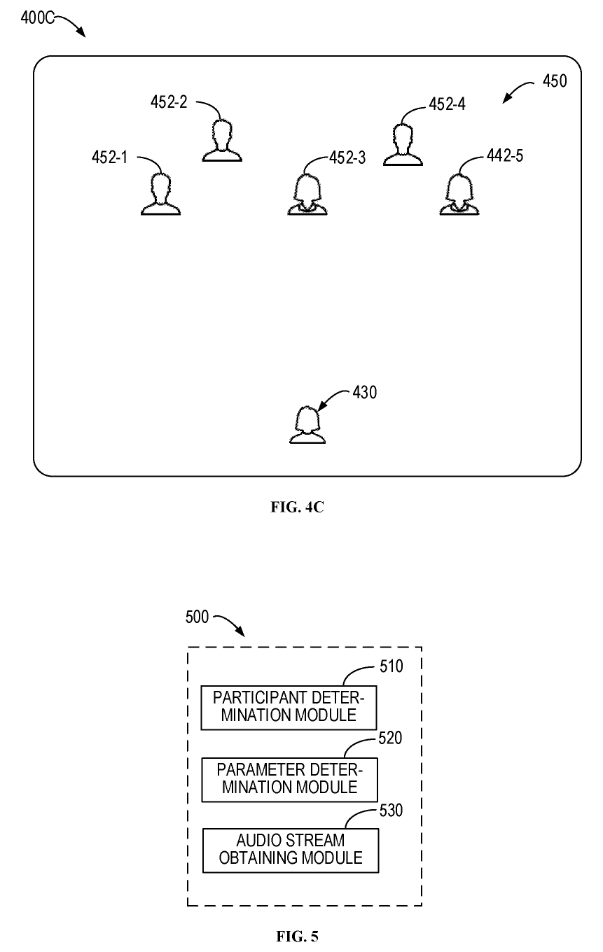

As an example, FIG. 4A illustrates a schematic diagram of an example 400A of a first layout of a live streaming chorus interface according to some embodiments of the present disclosure. As shown in FIG. 4A, the terminal device 120 may pre-establish a spatial coordinate system of the live streaming chorus interface, may define a front-back direction of the reference listening party as an X-axis direction, may define a left-right direction of the reference listening party as a Y-axis direction, and may define an up-down direction of the reference listening party as a Z-axis direction. The terminal device 120 may determine a spatial coordinate of the reference listening party as, for example, (0, 0, 0). The terminal device 120 may determine, in the live streaming chorus interface, a plurality of positions for arranging participants and respective spatial coordinates corresponding to the plurality of positions, such as positions 412-1, 412-2, 422-1, 422-2, and so on. The plurality of positions may indicate the chorus formation of the chorus event. The terminal device 110 may determine a position at which the at least one participant is arranged in the live streaming chorus interface, and determine a spatial coordinate corresponding to the participant based on the position at which each participant is arranged. Certainly, in practical applications, the relative positional relationship corresponding to the participant and the reference listening party may also be indicated by other spatial parameters, which is not limited to spatial coordinates.

The layout of participants on the live streaming chorus interface is exemplarily described below with reference to FIGS. 4A - 4C, but the layout on the live streaming chorus interface should not be construed as being limited to the layout shown below. In practical applications, any other appropriate layout may be selected according to actual needs.

In some embodiments, the layout on the live streaming chorus interface may include a first layout. The first layout indicates at least one first arrangement sequence, the at least one first arrangement sequence is away from the reference listening party sequentially, and each first arrangement sequence includes at least one position arranged along a straight line. Each position may be deployed with one participant. As an example, as shown in FIG. 4A, the first layout may include an arrangement sequence 410 and an arrangement sequence 420. The arrangement sequence 410 includes a position 412-1, a position 412-2, a position 412-3, and a position 412-4, which are arranged along a straight line. The arrangement sequence 420 includes a position 422-1, a position 422-2, a position 422-3, and a position 422-4, which are arranged along a straight line. The first layout may make the sound of the subsequently generated chorus audio stream more concentrated, and may improve the resonance of the sound. It should be understood that the first layout is not limited to including two arrangement sequences (which may also be referred to as each horizontal row), and may also include one arrangement sequence or more than three arrangement sequences. Each arrangement sequence is not limited to including four positions, and may also include other number of positions. The embodiments of the present disclosure are not specifically limited thereto.

In some embodiments, the layout on the live streaming chorus interface may include a second layout. The second layout indicates at least one second arrangement sequence, the at least one second arrangement sequence is away from the reference listening party sequentially, and each second arrangement sequence includes at least one position arranged along an arc. As an example, FIG. 4B illustrates a schematic diagram of an example 400B of a second layout of a live streaming chorus interface according to some embodiments of the present disclosure. As shown in FIG. 4B, the second layout may include an arrangement sequence 440, and the arrangement sequence 440 may include a position 442-1, a position 442-2, a position 442-3, a position 442-4, and a position 442-5, which are arranged along an arc. The second layout may also indicate a relative distance and a relative angle corresponding to the arrangement sequence 440 and the reference listening party 430. The second layout may improve the surround feeling of the subsequently generated chorus audio stream. It should be understood that the above layout is only exemplary. In practical applications, there may also be other predetermined music chorus layouts, for example, the arrangement sequence may also be wavy, or the arrangement sequence may also include straight segments and curved segments, etc. The embodiments of the present disclosure are not limited thereto.

In some embodiments, the streamer party or other participants may also flexibly create a music chorus layout according to actual needs. Specifically, if a layout request is received, the terminal device 120 may present an arrangement interface of the at least one participant. The terminal device 120 may determine a layout of the at least one participant based on an indication of an arrangement position of the at least one participant in the arrangement interface.

As an example, FIG. 4C illustrates a schematic diagram of an example 400C of an arrangement interface according to some embodiments of the present disclosure. As shown in FIG. 4C, if a layout request is received, the terminal device 120 may present the arrangement interface shown in the example 400C. The arrangement interface may present icons 452-1, 452-2, 452-3, 452-4, 452-5 for identifying arrangement positions. The streamer party may adjust the positions of the respective icons in the arrangement interface through the terminal device 120 or an attachment device of the terminal device 120. The terminal device 120 may determine that the indication of the arrangement position of the participant is received in response to an adjustment operation of the positions of the icons in the arrangement interface, and determine the layout of the at least one participant based on the layout of the plurality of icons in the arrangement interface. The layout may indicate that a plurality of participants may be arranged in an arrangement of the icons 452-1, 452-2, 452-3, 452-4, 452-5 to form a chorus queue, and the layout may also indicate relative distances and relative angles corresponding to the plurality of participants and the reference listening party 430.

In some embodiments, the terminal device 120 may determine the layout of the at least one participant on the live streaming chorus interface based on information related to music of the chorus event, to obtain the layout information corresponding to the at least one participant. The information related to the music may include but not limited to a structure of the music, a genre of the music, a singing method, a song type, a classification of lyrics content, etc. In this way, a music chorus layout matching with the music may be selected.

Alternatively or additionally, the terminal device 120 may determine the layout of the at least one participant on the live streaming chorus interface based on information related to the at least one participant, to obtain the layout information corresponding to the at least one participant. The information related to the at least one participant may include, but is not limited to, the number of the at least one participant, an acoustic feature (e.g., timbre, pitch, duration, intensity) of each participant, etc. In this way, a music chorus layout matching with the at least one participant may be selected.

Alternatively or additionally, the terminal device 120 may also determine the layout of the at least one participant on the live streaming chorus interface based on the information related to the music and the information related to the at least one participant. In this way, a music chorus layout matching with both the music and the participants may be selected, which is beneficial to improving the quality of the subsequently generated chorus audio stream.

Alternatively or additionally, the terminal device 120 may present a plurality of layouts (which may also be referred to as candidate layouts) for the user (e.g., the streamer party) to choose from. If a selection of one of the plurality of layouts is received, the terminal device 120 may determine the selected layout as the layout of the at least one participant on the live streaming chorus interface. The plurality of layouts here may include the first layout, the second layout, or other predetermined layouts, and the plurality of layouts may also include a layout created by the streamer party in advance. As an example, the streamer party may select a layout from predetermined layouts such as the first layout and the second layout, and the terminal device 120 determines the layout selected by the streamer party as the layout corresponding to the currently requested song based on the selection of the layout by the streamer party. In this way, the streamer party may customize the layout corresponding to the chorus event.

It should be noted that the above layout determination method is only exemplary. In practical applications, the layout of the at least one participant on the live streaming chorus interface may be a preset layout (e.g., preset to the above first chorus layout, the second chorus layout, or the music chorus layout created by the streamer party). The layout may also be a layout pre-configured by the streamer party in the configuration information of the live streaming (e.g., a layout pre-selected by the streamer party from the above first layout or the second layout). The layout may also be a layout set by the server 130. For example, the server 130 may determine the layout of the at least one participant on the live streaming chorus interface according to a predetermined rule. The terminal device 120 may determine the layout of the at least one participant on the live streaming chorus interface based on the indication of the layout by the server 130. The embodiments of the present disclosure are not limited thereto.

In some embodiments, the terminal device 120 may determine whether the number of the at least one participant exceeds a predetermined number. If it is determined that the number of the at least one participant exceeds the predetermined number, the terminal device 120 determines the at least one spatial parameter corresponding to the at least one participant respectively based on the layout information. If it is determined that the number of the at least one participant does not exceed the predetermined number, the terminal device 120 may forgo configuring the spatial parameter for the at least one participant. When the number of participants in the chorus is relatively small, voice overlap is less likely to occur. Even if the audio stream of the participant is not processed, the voice of each participant may usually be well distinguished, and the system resource consumption may be saved. When the number of participants in the chorus is relatively large, by processing the audio stream of each participant, voice overlap may be effectively avoided, which is beneficial to improving the quality of the subsequently generated chorus audio stream.

As an example, as shown in FIG. 3, the terminal device 120-1 may determine, based on the list of participants, whether the number of participants with the background singer role exceeds a predetermined number (e.g., 3). If it is determined that the number of participants with the background singer role exceeds the predetermined number, the terminal device 120-1 may enable (310) the spatial audio mode. After that, in the spatial audio mode, the terminal device 120-1 may determine the layout of the participants with the background singer role on the live streaming chorus interface, and determine (312) the spatial parameter of each participant with the background singer role based on the determined layout. It should be understood that the above method for determining the spatial parameter is only exemplary, and any other appropriate method may be selected to determine the spatial parameter of the participant. The embodiment of the present disclosure does not limit the method for determining the spatial parameter.

Returning to the procedure 200, at block 230, the terminal device 120 obtains a chorus audio stream for the chorus event, where the chorus audio stream is generated by processing at least one audio stream corresponding to the at least one participant using the at least one spatial parameter.

It should be noted that the generation process (which may also be referred to as merging) of the chorus audio stream may be implemented in the terminal device (e.g., the terminal device 120-1) associated with the streamer party of the chorus event, or may be implemented in the server 130. The generation process of the chorus audio stream will be described below with reference to FIG. 3 and taking the implementation of the generation process of the chorus audio stream in the server 130-2 as an example.

In the signaling flow 300, the terminal device 120-1 sends (314) a processing request to the server 130-2 associated with the chorus event. The processing request includes at least one spatial parameter. In some embodiments, the terminal device 120-1 may be deployed with a real-time communication engine (RTCSDK), and the terminal device 120-1 may send the processing request to the server 130-2 through the real-time communication engine.

In the signaling flow 300, the server 130-2 receives (316) an audio stream corresponding to the chorus event from the terminal device 120-2 of the participant. It should be noted that although only the terminal device 120-2 of the participant is shown in FIG. 3, in practical applications, the server 130-2 may receive audio streams from terminal devices of a plurality of participants. In a case that the streamer party participates in the chorus, the server 130-2 may also receive an audio stream from the terminal device 120-1 of the streamer party.

In the signaling flow 300, the server 130-2 performs (318) processing (which may also be referred to as spatialization processing) on a corresponding audio stream of the at least one audio stream based on each of the at least one spatial parameter, to obtain at least one spatially processed audio stream. After that, the server 130-2 generates (320) the chorus audio stream based at least on the at least one spatially processed audio stream. In some embodiments, the spatial parameter may include a spatial coordinate. The server 130-2 may perform spatialization processing on the corresponding audio stream based on each spatial coordinate to obtain the spatially processed audio stream.

In some embodiments, the at least one participant corresponds to a background singer role of the music. The server 130-2 may receive an audio stream from a participant corresponding to a lead singer role of the music. After that, the server 130-2 may generate the chorus audio stream based on the at least one spatially processed audio stream and the audio stream corresponding to the lead singer role of the music. In this way, the original audio features of the audio stream of the lead singer role may be relatively well preserved, or personalized processing may be performed on the audio stream of the lead singer role, which is favorable for highlighting the voice of the lead singer role in the chorus audio stream. As an example, assuming that the streamer party is the lead singer role, the server 130-2 may receive the audio stream of the lead singer role from the terminal device 120-1, and the server 130-2 may also receive the audio stream of the background singer role from the terminal device 120-2. The server 130-2 may perform spatialization processing on the audio stream of the background singer role based on the spatial coordinate. After that, the chorus audio stream is generated based on the audio stream of the lead singer role and the spatially processed audio stream of the background singer role.

In the signaling flow 300, the terminal device 120-1 may receive (322) the chorus audio stream from the server 130-2. The server 130-2 may also push (324) the chorus audio stream to the terminal device 120-2. Certainly, the server 130-2 may also push the chorus audio stream to other viewing parties of the live streaming. The server 130-2 performs the spatialization processing of the audio stream and the merging operation of the audio stream, which may reduce the system resource overhead of the terminal device 120-1 of the streamer party, and is favorable for improving the processing efficiency of the audio stream.

In some embodiments, the merging operation of the chorus audio stream may be configured to be performed by the terminal device 120. The terminal device 120 may receive at least one audio stream corresponding to the at least one participant. The terminal device 120 may perform spatialization processing on the corresponding audio stream of the at least one audio stream based on each of the at least one spatial parameter, to obtain at least one spatially processed audio stream. After that, the terminal device 120 generates the chorus audio stream at least by merging the at least one spatially processed audio stream.

As an example, the terminal device 120-1 may receive at least one audio stream of the at least one participant from the server 130-1 or the server 130-2. The terminal device 120-1 may perform spatialization processing on the corresponding audio stream based on the spatial coordinate of each participant to obtain the spatially processed audio stream. After that, the terminal device 120-1 may generate the chorus audio stream based on the spatially processed audio stream. After the chorus audio stream is generated, the terminal device 120-1 may push the chorus audio stream to the server 130-2, and the chorus audio stream is pushed by the server 130-2 to each viewing party.

In some embodiments, the at least one participant corresponds to a background singer role of the music. The terminal device 120 receives an audio stream from a participant corresponding to a lead singer role of the music. After that, the terminal device 120 generates the chorus audio stream based on the at least one spatially processed audio stream and the audio stream corresponding to the lead singer role. In this way, the original audio features of the audio stream of the lead singer role may be relatively well preserved, which is favorable for highlighting the voice of the lead singer role in the chorus audio stream.

It should be noted that during the chorus event, the participants participating in the chorus may be dynamically changed, and the spatialization processing of the audio stream and the generation of the synthesized audio stream may be continuously performed. Therefore, during the chorus event, the above process may be repeated a plurality of times.

In this way, in the embodiments of the present disclosure, processing the corresponding audio stream using the spatial parameter may form the audio stream having the spatial audio effect. The chorus audio stream formed by merging audio streams based on the spatial audio effect may simulate, to a certain extent, the sound effect of music chorus in the chorus formation corresponding to the corresponding layout, which may bring immersive audio-visual experience to the listeners. Moreover, voice overlap is not likely to occur in the chorus audio stream, so that the listeners may distinguish voices of more participants from the chorus audio stream, which in turn allows more participants to participate in the chorus event.

### Example Apparatus and Device

The embodiments of the present disclosure further provide corresponding apparatuses for implementing the above methods or procedures. FIG. 5 illustrates a schematic structural block diagram of an example apparatus 500 for audio processing according to some embodiments of the present disclosure. The apparatus 500 may be implemented as or included in the terminal device 120. Each module/component in the apparatus 500 may be implemented by hardware, software, firmware, or any combination thereof.

As shown in FIG. 5, the apparatus 500 includes: a participant determination module 510 configured to determine at least one participant joining a chorus event of live streaming; a parameter determination module 520 configured to determine at least one spatial parameter corresponding to the at least one participant respectively based on layout information corresponding to the at least one participant, the layout information indicating a layout of the at least one participant on a live streaming chorus interface, and each of the at least one spatial parameter indicating a relative positional relationship corresponding to a participant and a reference listening party; and an audio stream obtaining module 530 configured to obtain a chorus audio stream for the chorus event, the chorus audio stream being generated by: processing at least one audio stream corresponding to the at least one participant using the at least one spatial parameter.

In some embodiments, the participant determination module 510 is further configured to: determine the at least one participant from a plurality of participants based on respective roles of the plurality of participants joining the chorus event, a role of each participant indicating whether the participant is a lead singer role or a background singer role in the chorus event.

In some embodiments, the parameter determination module 520 is further configured to: determine whether a number of the at least one participant exceeds a predetermined number; and in response to determining that the number of the at least one participant exceeds the predetermined number, determine the at least one spatial parameter corresponding to the at least one participant respectively based on the layout information.

In some embodiments, the layout information is determined based on at least one of: information related to music of the chorus event, information related to the at least one participant, or a selection of a layout from a plurality of layouts.

In some embodiments, the apparatus 500 further includes: a layout information determination module configured to: present an arrangement interface for the at least one participant in response to a layout request; and determine the layout of the at least one participant on the live streaming chorus interface to obtain the layout information based on an indication of an arrangement position of the at least one participant in the arrangement interface.

In some embodiments, the layout includes one of: a first layout indicating at least one first arrangement sequence, the at least one first arrangement sequence being away from the reference listening party sequentially, each first arrangement sequence including at least one position arranged along a straight line, and a second layout indicating at least one second arrangement sequence, the at least one second arrangement sequence being away from the reference listening party sequentially, each second arrangement sequence including at least one position arranged along an arc.

In some embodiments, the apparatus 500 is implemented as or included in a terminal device associated with a streamer party of the chorus event, and the audio stream obtaining module 530 is further configured to: send a processing request to a server associated with the chorus event, the processing request including at least the at least one spatial parameter; and receive the chorus audio stream from the server.

In some embodiments, the apparatus 500 is implemented as or included in a terminal device associated with a streamer party of the chorus event, and the audio stream obtaining module 530 is further configured to: receive at least one audio stream corresponding to the at least one participant; perform, based on each of the at least one spatial parameter, processing on a corresponding audio stream of the at least one audio stream to obtain at least one processed audio stream; and generate the chorus audio stream at least by merging the at least one processed audio stream.

In some embodiments, the at least one participant corresponds to a background singer role in the chorus event, and the audio stream obtaining module 530 is further configured to: receive an audio stream from a participant corresponding to a lead singer role in the chorus event; and generate the chorus audio stream based on the at least one processed audio stream and an audio stream corresponding to the lead singer role.

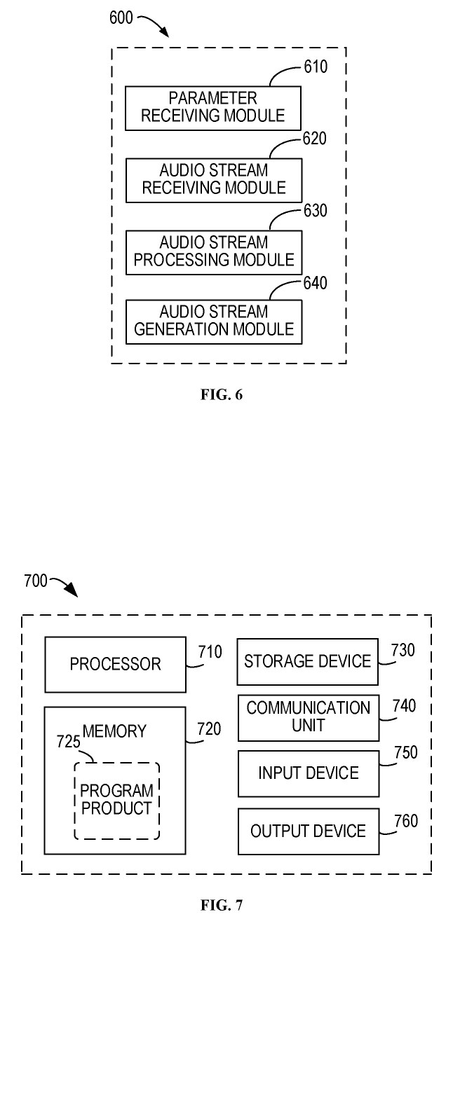

FIG. 6 illustrates a schematic structural block diagram of an example apparatus 600 for audio processing according to some embodiments of the present disclosure. The apparatus 600 may be implemented as or included in the server 130. Each module/component in the apparatus 600 may be implemented by hardware, software, firmware, or any combination thereof.

As shown in FIG. 6, the apparatus 600 includes: a parameter receiving module 610 configured to receive, from a terminal device associated with a streamer party of a chorus event of live streaming, at least one spatial parameter indicating a relative positional relationship corresponding to at least one participant joining the chorus event and a reference listening party, respectively; an audio stream receiving module 620 configured to receive at least one audio stream corresponding to the chorus event from the at least one participant; an audio stream processing module 630 configured to perform, based on each of the at least one spatial parameter, processing on a corresponding audio stream of the at least one audio stream to obtain at least one processed audio stream; and an audio stream generation module 640 configured to generate a chorus audio stream at least based on the at least one processed audio stream.

In some embodiments, the at least one participant corresponds to a background singer role in the chorus event, and the audio stream generation module 640 is further configured to: receive an audio stream from a participant corresponding to a lead singer role in the chorus event; and generate the chorus audio stream based on the at least one processed audio stream and an audio stream corresponding to the lead singer role in the chorus event.

In some embodiments, the apparatus 600 further includes: an audio stream pushing module configured to push the chorus audio stream to a viewing party of the chorus event.

The units and/or modules included in the apparatuses 500 and 600 may be implemented in various ways, including software, hardware, firmware, or any combination thereof. In some embodiments, one or more units and/or modules may be implemented using software and/or firmware, such as machine-executable instructions stored on a storage medium. In addition to machine-executable instructions or as an alternative, some or all units and/or modules in the apparatuses 500 and 600 may be implemented, at least in part, by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), etc.

FIG. 7 illustrates a block diagram of an electronic device 700 in which one or more embodiments of the present disclosure may be implemented. It should be understood that the electronic device 700 shown in FIG. 7 is only exemplary, and should not constitute any limitation on the function and scope of the embodiments described herein. The electronic device 700 shown in FIG. 7 may include or be implemented as the terminal device 120 or the server 130 in FIG. 1, the apparatus 500 in FIG. 5, or the apparatus 600 in FIG. 6.

As shown in FIG. 7, the electronic device 700 is in the form of a general electronic device. The components of the electronic device 700 may include but be not limited to one or more processors 710, a memory 720, a storage device 730, one or more communication units 740, one or more input devices 750, and one or more output devices 760. The processor 710 may be an actual or virtual processor, and may execute various processes based on the executable instructions stored in the memory 720. In a multi-processor system, a plurality of processors execute computer executable instructions in parallel to improve the parallel processing capability of the electronic device 700.

The electronic device 700 typically includes a plurality of computer storage medium. Such medium may be any available medium that is accessible to the electronic device 700, including, but not limited to, volatile and non-volatile medium, removable and non-removable medium. The memory 720 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 730 may be a removable or non-removable medium, and may include a machine-readable medium such as a flash drive, a disk, or any other medium, which may be used to store information and/or data and may be accessed within the electronic device 700.

The electronic device 700 may further include additional removable/non-removable, volatile/non-volatile memory medium. Although not shown in FIG. 7, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 720 may include a computer program product 725 having one or more executable instruction modules configured to perform various methods or acts of various embodiments of the present disclosure.

The communication unit 740 enables communication with other electronic devices through the communication medium. In addition, the functions of the components of the electronic device 700 may be implemented by a single computing cluster or a plurality of computing machines, which may communicate through communication connections. Therefore, the electronic device 700 may use a logical connection with one or more other servers, a network personal computer (PC), or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may further communicate with one or more external devices (not shown) through the communication unit 740 as needed, the external devices such as a storage device, a display device, etc., communicate with one or more devices that enable the user to interact with the electronic device 700, or communicate with any devices (such as a network card, a modem, etc.) that enable the electronic device 700 to communicate with one or more other electronic devices. Such communication may be performed via input/output (I/O) interfaces (not shown).

According to an exemplary implementation of the present disclosure, there is provided a computer-readable storage medium having computer-executable instructions stored thereon, where the computer-executable instructions are executed by a processor to implement the method described above. According to an exemplary implementation of the present disclosure, there is further provided a computer program product tangibly stored on a non-transitory computer-readable medium and including computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer-readable executable instructions.

These computer-executable instructions may be provided to a processor of a general-purpose computer, a special-purpose computer, or other programmable data processing apparatus to produce a machine, such that these instructions, when executed by the processor of the computer or other programmable data processing apparatus, produce an apparatus for implementing the functions/acts specified in one or more blocks of the flowcharts and/or block diagrams. These computer-executable instructions may also be stored in a computer-readable storage medium, these instructions cause the computer, the programmable data processing apparatus, and/or other devices to work in a specific manner, and thus, the computer-readable medium storing the instructions includes a manufactured product, which includes instructions for implementing various aspects of the functions/acts specified in one or more blocks of the flowcharts and/or block diagrams.

The computer-executable instructions may be loaded onto a computer, another programmable data processing apparatus, or another device, such that a series of operations and steps are performed on the computer, the another programmable data processing apparatus, or the another device to produce a computer-implemented procedure, such that the instructions executed on the computer, the another programmable data processing apparatus, or the another device implement the functions/acts specified in one or more blocks of the flowcharts and/or block diagrams.

The flowcharts and block diagrams in the drawings show the possibly implemented architectures, functions, and operations of the system, the method, and the computer program product according to a plurality of implementations of the present disclosure. In this regard, each block in the flowchart or block diagram may represent a module, an executable instruction, or a part of an instruction, and the module, the executable instruction, or the part of the instruction contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of the blocks in the block diagrams and/or flowcharts may be implemented by a special-purpose hardware-based system that perform specified functions or acts, or may be implemented by a combination of special-purpose hardware and computer instructions.

The implementations of the present disclosure have been described above, and the above description is exemplary, non-exhaustive, and not limited to the disclosed implementations. Many modifications and variations will be apparent to those of ordinary skill in the art without departing from the scope and spirit of the described implementations. The terms used herein are chosen to best explain the principles of the implementations, the practical applications, or improvements to the technologies in the market, or to enable other those of ordinary skill in the art to understand the implementations disclosed herein.

1. A method of audio processing, comprising:
determining at least one participant joining a chorus event of a live streaming;
determining at least one spatial parameter corresponding to the at least one participant respectively based on layout information corresponding to the at least one participant, the layout information indicating a layout of the at least one participant on a live streaming chorus interface, and each of the at least one spatial parameter indicating a relative positional relationship corresponding to a participant and a reference listening party; and
obtaining a chorus audio stream for the chorus event, the chorus audio stream being generated by: processing at least one audio stream corresponding to the at least one participant using the at least one spatial parameter.

2. The method of claim 1, wherein determining the at least one participant comprises:
determining the at least one participant from a plurality of participants based on respective roles of the plurality of participants joining the chorus event, wherein a role of each participant indicates whether the participant is a lead singer role or a background singer role in the chorus event.

3. The method of claim 1, wherein determining at least one spatial parameter corresponding to the at least one participant respectively comprises:
determining whether a number of the at least one participant exceeds a predetermined number; and
in response to determining that the number of the at least one participant exceeds the predetermined number, determining the at least one spatial parameter corresponding to the at least one participant respectively based on the layout information.

4. The method of claim 1, wherein the layout information is determined based on at least one of:
information related to music of the chorus event,
information related to the at least one participant, or
a selection of the layout from a plurality of layouts.

5. The method of claim 1, wherein the layout information is determined by:
presenting an arrangement interface for the at least one participant in response to a layout request; and
determining the layout of the at least one participant on the live streaming chorus interface to obtain the layout information based on an indication of an arrangement position of the at least one participant in the arrangement interface.

6. The method of claim 1, wherein the layout comprises one of:
a first layout indicating at least one first arrangement sequence, the at least one first arrangement sequence being away from the reference listening party sequentially, each first arrangement sequence comprising at least one position arranged along a straight line, and
a second layout indicating at least one second arrangement sequence, the at least one second arrangement sequence being away from the reference listening party sequentially, each second arrangement sequence comprising at least one position arranged along an arc.

7. The method of claim 1, wherein the method is implemented at a terminal device associated with a streamer party of the chorus event, and wherein obtaining the chorus audio stream for the chorus event comprises:
sending a processing request to a server associated with the chorus event, the processing request comprising at least the at least one spatial parameter; and
receiving the chorus audio stream from the server.

8. The method of claim 1, wherein the method is implemented at a terminal device associated with a streamer party of the chorus event, and wherein obtaining the chorus audio stream for the chorus event comprises:
receiving the at least one audio stream corresponding to the at least one participant;
performing, based on each of the at least one spatial parameter, processing on a corresponding audio stream of the at least one audio stream to obtain at least one processed audio stream; and
generating the chorus audio stream at least by merging the at least one processed audio stream.

9. The method of claim 8, wherein the at least one participant corresponds to a background singer role in the chorus event, and wherein generating the chorus audio stream comprises:
receiving an audio stream from a participant corresponding to a lead singer role in the chorus event; and
generating the chorus audio stream based on the at least one processed audio stream and an audio stream corresponding to the lead singer role.

10. A method of audio processing implemented at a server, the method comprising:
receiving, from a terminal device associated with a streamer party of a chorus event of a live streaming, at least one spatial parameter indicating a relative positional relationship corresponding to at least one participant joining the chorus event and a reference listening party, respectively;
receiving at least one audio stream corresponding to the chorus event from the at least one participant;
performing, based on each of the at least one spatial parameter, processing on a corresponding audio stream of the at least one audio stream to obtain at least one processed audio stream; and
generating a chorus audio stream at least based on the at least one processed audio stream.

11. The method of claim 10, wherein the at least one participant corresponds to a background singer role in the chorus event, and wherein generating the chorus audio stream comprises:
receiving an audio stream from a participant corresponding to a lead singer role in the chorus event; and
generating the chorus audio stream based on the at least one processed audio stream and an audio stream corresponding to the lead singer role in the chorus event.

12. The method of claim 10, further comprising:
pushing the chorus audio stream to a viewing party of the chorus event.

13. An electronic device, comprising:
at least one processor; and
at least one memory coupled to the at least one processor and storing instructions executable by the at least one processor, the instructions, when executed by the at least one processor, causing the electronic device to perform operations comprising:
determining at least one participant joining a chorus event of a live streaming;
determining at least one spatial parameter corresponding to the at least one participant respectively based on layout information corresponding to the at least one participant, the layout information indicating a layout of the at least one participant on a live streaming chorus interface, and each of the at least one spatial parameter indicating a relative positional relationship corresponding to a participant and a reference listening party; and
obtaining a chorus audio stream for the chorus event, the chorus audio stream being generated by: processing at least one audio stream corresponding to the at least one participant using the at least one spatial parameter.

14. The electronic device of claim 13, wherein determining the at least one participant comprises:
determining the at least one participant from a plurality of participants based on respective roles of the plurality of participants joining the chorus event, wherein a role of each participant indicates whether the participant is a lead singer role or a background singer role in the chorus event.

15. The electronic device of claim 13, wherein determining at least one spatial parameter corresponding to the at least one participant respectively comprises:
determining whether a number of the at least one participant exceeds a predetermined number; and
in response to determining that the number of the at least one participant exceeds the predetermined number, determining the at least one spatial parameter corresponding to the at least one participant respectively based on the layout information.

16. The electronic device of claim 13, wherein the layout information is determined based on at least one of:
information related to music of the chorus event,
information related to the at least one participant, or
a selection of the layout from a plurality of layouts.

17. The electronic device of claim 13, wherein the layout information is determined by:
presenting an arrangement interface for the at least one participant in response to a layout request; and
determining the layout of the at least one participant on the live streaming chorus interface to obtain the layout information based on an indication of an arrangement position of the at least one participant in the arrangement interface.

18. The electronic device of claim 13, wherein the layout comprises one of:
a first layout indicating at least one first arrangement sequence, the at least one first arrangement sequence being away from the reference listening party sequentially, each first arrangement sequence comprising at least one position arranged along a straight line, and
a second layout indicating at least one second arrangement sequence, the at least one second arrangement sequence being away from the reference listening party sequentially, each second arrangement sequence comprising at least one position arranged along an arc.

19. The electronic device of claim 13, wherein the electronic device is associated with a streamer party of the chorus event, and wherein obtaining the chorus audio stream for the chorus event comprises:
sending a processing request to a server associated with the chorus event, the processing request comprising at least the at least one spatial parameter; and
receiving the chorus audio stream from the server.

20. The electronic device of claim 13, wherein the electronic device is associated with a streamer party of the chorus event, and wherein obtaining the chorus audio stream for the chorus event comprises:
receiving the at least one audio stream corresponding to the at least one participant;
performing, based on each of the at least one spatial parameter, processing on a corresponding audio stream of the at least one audio stream to obtain at least one processed audio stream; and
generating the chorus audio stream at least by merging the at least one processed audio stream.
